(19) United States
(12) Patent Application Publication
(10) Pub. No.: US 2014/0129330 A1
(43) Pub. Date: May 8, 2014

(54) Methods for Targeted Advertising

(71) Applicant: Velvet Ape, Inc., Holly, MI (US)

(72) Inventor: Mack A. Fuller, Holly, MI (US)

(73) Assignee: Velvet Ape, Inc., Holly, MI (US)

(21) Appl. No.: 14/071,508

(22) Filed: Nov. 4, 2013

Related U.S. Application Data
(60) Provisional application No. 61/722,617, filed on Nov. 5, 2012.

(51) Int. Cl. G06Q 30/02

(52) U.S. Cl. CPC G06Q 30/0255
USPC 705/14.53

(57) ABSTRACT

The invention described herein solves challenges encountered in targeted advertisement. Methods for targeted advertisement of non-agnostic consumer markets are disclosed. Examples describe a system wherein consumer input informs the method of targeted advertisement.

### CROSS REFERENCE

This application claims the benefit of U.S. Provisional Patent Application Ser. No. 61/722,617, filed on Nov. 5, 2012, the contents of which is incorporated herein by reference in its entirety.

### BACKGROUND

Advertising is ubiquitous, and as media expands into all aspects of people's lives, advertising does the same. Although advertising is an effective method for presenting products to the masses, rarely ever does a product appeal to the masses. Creative artistry, engineering, software development, acting, and endless financing are combined into ad campaigns that inefficiently distribute information largely to people who have no desire to receive the same. As media becomes a mainstay of private residences, ineffective advertising enters private residences, and frequently alienates more viewers than are seduced by the efforts of the advertiser.

### SUMMARY OF THE INVENTION

In some embodiments, the invention provides a method of advertising to a media user, the method comprising: a) monitoring the media user's media entertainment to detect an interest of the media user in a consumer market based on an interaction of the media user with the media, wherein the monitoring and the detecting are performed by a computer system; b) launching by the computer system a module within the media; c) presenting to the media user via the module a first plurality of selectable icons based on the media user's interest, wherein each selectable icon is associated with the consumer market; d) detecting by the computer system that one of the selectable icons has been selected, wherein the selectable icon that has been selected has an identity; e) searching by the computer system a database of advertisements, wherein the search is based on the identity of the selectable icon that has been selected, to identify an advertisement associated with the consumer market, wherein the computer system comprises a processor, and the search is performed by the processor; and f) presenting to the media user via the media the advertisement associated with the consumer market.

In some embodiments, the invention provides a method of accessing advertising on media by a media user, the method comprising: a) accessing on the media by the media user a module associated with a media entertainment experience, wherein the module presents to the media user a plurality of selectable icons, wherein each selectable icon is associated with a consumer market associated with the entertainment experience; b) selecting by the media user one of the selectable icons, thereby selecting the consumer market associated with the selectable icon that was selected, wherein the selection alerts a computer system that the media user selected the selectable icon that was selected, whereupon the computer system searches a database for an advertisement associated with the consumer market associated with the selectable icon that was selected and presents the advertisement to the media user, wherein the search is performed by a processor; and c) receiving the advertisement by the media user via the media.

In some embodiments, the invention provides a computer program product comprising a computer-readable medium having computer-executable code encoded therein, the computer-executable code adapted to be executed to implement a method for targeting advertising to a media user, the method comprising: a) providing an advertising targeting system, wherein the advertising targeting system comprises: i) a monitoring module; ii) a first query module; iii) a search module; and iv) an advertising output module; b) monitoring the media user's media access via the monitoring module to detect an interest of the media user in a consumer market; c) querying the media user with a first query by the first query module, based on the interest, wherein the first query presents to the media user a first plurality of selectable icons associated with the interest; d) detecting by the first query module that one of the selectable icons has been selected, wherein the selectable icon that has been selected has an identity; e) searching by the search module a database of advertisements based on the identity of the selectable icon that has been selected, wherein the search identifies an advertisement associated with the selectable icon that was selected; and f) outputting by the advertising output module to the media user over the media the advertisement associated with the selectable icon that was selected.

### BRIEF DESCRIPTION OF THE FIGURES

FIG. 1 illustrates a user interaction with a system of the invention.

FIG. 2 is a non-limiting illustration of different parties interacting with a system of the invention.

FIG. 3 is a block diagram illustrating a first example architecture of a computer system that can be used in connection with example embodiments of the present invention.

FIG. 4 is a diagram illustrating a computer network that can be used in connection with example embodiments of the present invention.

FIG. 5 is a block diagram illustrating a second example architecture of a computer system that can be used in connection with example embodiments of the present invention.

### DETAILED DESCRIPTION

Media users and advertisers share the same problem: pairing the correct consumer product with the correct consumer is difficult. Traditional blanket advertising does not target a user who is interested in a certain market or is susceptible to entering the market. Rather, blanket advertising provides mass exposure, fueled by a questionable hope that a random viewer will be seduced. Advertisers ignore the wants of the individual in favor of impersonal and ineffective overexposure.

Consumers still want to find the exact product to meet their needs. For example: a lawyer quickly wants to find the best briefcase, a mother wants the right stroller, a teenager wants to find the right outfit, and an executive wants to find the right gadget. However, in the midst of informational overflow, consumers find themselves spending more and more time searching for the right product.

The problem is more severe in cases of niche consumer products. A niche manufacturer needs to reach a specific segment of the population, and the expense of advertising to the masses is wasteful and unproductive. Consumers interested in niche products are seldom exposed to advertisement of products of interest. Niche advertising, to be effective, requires effective targeting of the desired consumers to be productive. Still, the advertiser can only guess about what products a consumer might wish to learn more.

Rather than randomly present product information to a consumer, an advertiser can be more effective by allowing the consumer to seek product information and niches of interest to the particular consumer. The consumer is more likely to receive the advertising favorably, review the content, and purchase a product when the consumer has the power to find what the consumer wants quickly and easily. The invention disclosed herein provides the consumer with the ability to find product information for desired products and niches, and provides advertisers with a direct line to prompt consumers to seek the advertisers. Most importantly, the present invention makes advertising fun for the consumer.

The adventure begins with a consumer enjoying an ordinary media experience on a media device. Non-limiting examples of media devices include personal computers, telephones, televisions, and video game consoles. Non-limiting examples of media experiences include web browsing; downloading files; listening to sounds, music, or voice clips; watching a program, such as a television program; playing a game; composing e-mail; texting; conversing; and otherwise participating in a media entertainment experience. In some embodiments, the media experience is shopping. In some embodiments, the media experience is not shopping.

A system of the invention monitors the consumer's media experience and observes the consumer's interactions with the media. The observations allow the system to detect an interest of the consumer based on interactions between the consumer and the media. Non-limiting examples of ways that the system can detect a consumer's interaction with media include clicks; history, such as browsing history, channel history, chat logs, and call logs; cookies; and pixel sequences of images displayed on the media. Monitoring can take place, for example, on one, two, three, or all of a personal computer, a television, a telephone, and a video game console. Monitoring can be apparent to the consumer or silent in the background. The output of the monitoring is reported to a central hub, where a computer system processes the output to determine the consumer market preferences on the consumer using the foregoing devices.

In some embodiments, the monitoring is performed by a monitoring module. In some embodiments, detection of pixel sequences are detected by a pixel sequencing module.

Consumer market preferences can reflect the purchasing interests of the consumer. A consumer market can be, for example, a mass market or a niche market. Non-limiting examples of consumer markets include: clothes, food, movies, games, cosmetics, personal products, convenience products, emergency products, collectibles, anime, entertainment, furniture, appliances, music, electronics, kitchenware, stationary, eyeware, literature, nutritional supplements, fragrances, and toys.

A system of the invention allows consumers to access an interface. Consumers can request tailored product information as advertisement on demand. A consumer can populate a profile with information such as name, email address, hobbies, interests, and areas of interest to guide on demand advertisement.

A system of the invention presents consumers on mobile and desktop devices with choices of consumer markets, including niche markets. A user can interact with the interface of the system of the invention to direct their experience. A system of the invention can connect products to consumers effectively establishing a connection between consumers and a consumer market of choice.

In some embodiments, the system of the invention is a virtual catalog targeting consumer markets chosen by the consumer.

Connecting with a Consumer Market of Choice.

Once a consumer interest has been identified, a system of the invention can launch a program, such as a module, window, or pop-up, within the media associated with the consumer. The consumer can access or ignore the program. The program presents information to the consumer based on the interest identified previously. The information can relate to a consumer market associated with the interest previously detected by the system. The program can present the user with a series of options, for example, selectable icons. The selectable icons chosen for presentation to the consumer relate to the consumer's identified interest. Each icon, for example, represents a different aspect or niche of the consumer market, and suggests a product or class of products about which the consumer might be interested in learning more. The consumer can select on any of the icons to learn more about the niches or products, and gain information about how to purchase items of the desired category. In some embodiments, upon selecting an icon, the consumer is presented with a second, third, fourth, or further series of icons, each delving more narrowly and specifically into the market of interests, assisting the consumer in finding products of interest. Selecting a selectable icon can be done, for example, by clicking a clickable icon, dragging and dropping an icon, sliding a selectable icon, or by voice recognition of an icon to a command. The user can navigate the system by, for example, selecting one or a plurality of selectable icons.

In some embodiments, the icons are presented to the consumer via a query module, such as a first query module, a second query module, a third query module, a fourth query module, a fifth query module, a sixth query module, a seventh query module, an eighth query module, a ninth query module, a tenth query module, and optionally further query modules. Each successive query module can probe deeper into a consumer market and provide options and information at higher levels of specificity to give the consumer the most beneficial and productive product search experience. The query module can also detect that a selectable icon has been selected.

The consumer can select an icon, whereupon a system of the invention recognizes that an icon has been selected. The computer system associates the selected icon, for example, with a market, a consumer market, a submarket, or a niche market, and uses the association to guide a search for advertising likely to appeal to the consumer. The computer system searches a database of advertisements to identify those associated with the icons selected by the consumer. Ultimately, the search finds advertisements associated with the consumer's interest.

In some embodiments, the search is performed by a search module. In some embodiments the search includes a library of product information and advertisement provided by partner organizations. Non-limiting examples of partner organizations include advertisers, media companies, publishers, and merchants.

Once the desired advertisements have been identified, the advertisements are presented to the consumer over media. The consumer then has the opportunity to browse, enjoy, and select advertisements. In doing so, the consumer can learn about products of potential interest, and contemplate purchases. The consumer can be presented with advertisements for products that the consumer wanted, and with advertisements for products that the consumer might not have considered previously, but reasonably could consider based on the consumer's selections and the interest detected by the system of the invention.

A system of the invention can identify that one of the selectable icons has been selected, presenting to the media user via the media a second plurality of selectable icons, wherein each selectable icon of the second plurality is independently associated with a submarket within the consumer market. This process identifies style preferences and selects advertisements tailored to a consumer's personal taste.

In some embodiments, the system of the invention provides customers, advertisers, merchants and publishers with a survey of questions that determines their fit into a consumer market. The system of the invention can accommodate any number of choices. For example, consumers can select “fashion” as one of their interests and subsequently choose “shoes” as a preferred subcategory within fashion. Consumers, advertisers, merchants, and publishers can select on any number of selectable icons that are associated with a consumer market associated with the entertainment experience.

Advertisers can determine their fit into any number of consumer markets by answering, for example, a survey of selectable questions. Advertisers can, for example, extend their reach into digital markets, create an online standard, and generate bidding for their products. Advertisers can run one or any number of ads, sequentially or intermittently, in any number of consumer media. Advertisers can choose to target the distribution of creatives to specific core audiences or for general audiences, effectively reaching target consumers.

Non limiting examples of advertisers include for profit organizations, non-profit organizations, charities, and churches.

Merchants can determine their fit into any number of consumer markets by answering, for example, a survey of selectable questions. Merchants can, for example, organize test runs of creatives and obtain quantitative and qualitative feedback from consumers interacting with the systems of the invention. Merchants can, for example, outsource their consumer marketing departments to the system of the invention to secure inventory space and obtain help with marketing of stock overflow.

Publishers can determine their fit into any number of consumer markets by, for example, answering a survey of selectable questions. Publishers can, for example, choose to monetize a blog, an application, a book, or an event by publicizing with the system of the invention.

In some embodiments, the system of the invention identifies the consumer market from information embedded in, for example, video game discs, live internet gaming session(s), and downloaded game applications in video game consoles, personal computers, tablets, televisions, and a plurality of different media devices. The system of the invention can launch one or more modules, which present selectable icon(s) notifying consumers of available products associated with the game. The icons can be displayed when the game is being played, at save points, or at intermissions. For example, a consumer engagement with an online poker videogame can prompt the system of the invention to notify the gamer of an upcoming poker tournament. Watching a Japanese-themed cartoon on a television or personal computer can prompt the launch of a range of anime targeted consumer market products.

In some embodiments, a system of the invention can assist in selecting products for a consumers' personal use. In some embodiments, a system of the invention can assist in selecting products for any recipient and any occasion. In some embodiments, a system of the invention can assist offices and corporate organizations in identifying and purchasing institutional supplies.

In some embodiments, the advertising is presented to the consumer by an advertising output module. Consumers can actively interact with the interface of the system of the invention and provide input that customizes the product information received. Consumers can choose not to interact with the interface of the system. Active and/or passive interaction with the systems of the invention can provide benefits to the consumer, such as coupons, online and in-store sales, participation in loyalty programs, and statement credits.

An individual's online presence in social media and non-social media sites can be used to identify product preferences. Non-limiting examples of social media sites include Facebook™, Twitter™, Sina Weibo™, and Linkedin™.

The efficiency and quality of the process can be improved by monitoring the same consumer's media experiences across multiple media devices. Monitoring can take place across two, three, four, or more media devices. Non-limiting examples of such devices include a personal computer, a television, a telephone, and a video game console. In some embodiments, the media devices are in communication with a common host, such as a hub, a network, an internet, an intranet, a server, a domain, or a computer system. In some embodiments, communication takes place via a communication module.

### Systems of the Invention.

In some embodiments, the invention is provided in the form of a computer program product comprising a computer-readable medium having computer-executable code encoded therein, the computer-executable code adapted to be executed to implement a method for targeting advertising to a media user. Non-limiting examples of computer-readable media include hard disk, floppy disk, magnetic tape, flash drive, USB, CD, DVD, and Blu-Ray. Non-limiting examples of computer-executable code include bytecodes and portable codes such as Java, Small Talk, JIT, Python, PHP, CSS, HTML5, DHTML, Forth, LLVM, and C++.

A computer-executable code can execute a method comprising providing an advertising targeting system, wherein the advertising targeting system comprises one, more than one, or all of: a monitoring module, a first query module, a second query module, a search module, an advertising output module, a pixel sequencing module, a communication module.

A system of the invention can comprise a computer program product that is installed on a personal computer, a television, a telephone, a video game console and/or a plurality of mobile devices. A system of the invention can comprise a computer program product that is virtually accessed and not installed on a personal computer, a television, a video game console and/or a plurality of mobile devices.

A system of the invention can comprise a computer program product that is constantly received by and presented to an end-user while being delivered by a provider, for example, by streaming media, and live streaming. A system of the invention can use a plurality of different network protocols, for example, user-datagram-protocol(s) (UDP), real-time-streaming-protocol(s) (RTSP), real-time-transport-protocol(s) (RTP), the real-time-transport-control-protocol(s) (RTCP), adaptative bitrate streaming, and transmission-control-protocol(s) (TCP) to deliver advertisement.

In some embodiments, the system of the invention provides a method of accessing advertising on media by a media user. Non-limiting examples of media include a personal computer, a television, a telephone, a video game, and a plurality of mobile devices. For instance a consumer can watch a television show associated with the fashion industry. A system of the invention can match the consumer's interest in fashion and offer industry-relevant product information as an advertisement on the television screen. A consumer can choose to ignore the advertisement or a consumer can select a series of selectable icons with further product information. A consumer can choose to save the product information for later review. A consumer can choose to review and purchase the advertised item. In the case of purchase, a consumer can review the cost, and provide information for shipping and payment.

A system of the invention allows the interface to function on smartphone(s), tablet(s), desktop computer(s), laptop computer(s) and a plurality of mobile devices with a plurality of different interfaces and operating systems. This versatility allows a user to have access to the system of the invention on a plurality of distinct devices.

A system of the invention can archive the data browsing activities performed on devices associated with the system of the invention. A system of the invention can also archive the data on a centralized data source. For example, if a customer selects on one or more icons with information on “internet games”, the system of the invention can archive that data to create a library with the interests of that customer. The archive can guide future product suggestions and can provide more rapid advertising delivery. The archive can store information related to viewed icons, selected icons, and purchased items, which can be used to establish a consumers profile over time.

A consumer identity profile can be used by the method of the invention to identify the consumer market preferences of a media user. In some embodiments, monitoring a media user's media entertainment use by a computer system is used to shape a consumer identity profile. In some embodiments, detecting a media user's interaction with the method of invention is used to shape a consumer identity profile. For example video game consumers playing video games associated with the genre “anime” can have a consumer identity profile listing “anime” as a consumer market preference.

A consumer profile identity is shaped when, for example: a) a consumer interacts with a plurality of media sources, for example, by watching a television show, by surfing the internet, and by downloading a game on a mobile device; b) a consumer selects any number of selectable icons presented by the system of the invention within a plurality of media devices; or c) the system searches a database of advertisement based on the identity of the selectable icons selected in previous interaction(s). In one embodiment, identifiable user data such as, for example, IP addresses, cookie ID, domain names, telephone numbers, and user log in profiles can be used to identify preferred consumer markets.

A system of the invention can shape a consumer profile identity by identifying when a media user reads and writes to the same memory location with methods such as, for example, cache coherence. A media user can, for example: a) record, retrieve, and watch television programs on a DVR; b) play, record, retrieve, and save progress on a video-game; and c) read, save, share, and modify articles from journals, magazines, and newspapers.

A system of the invention can shape a consumer identity profile when a media user uses computing resources (hardware and software) that are delivered as a service over a network, such as the services delivered via cloud computing. For example, a media user can access cloud-based applications through a web browser or a desktop or mobile application while the business software and user's data are stored on servers at a remote location. In some embodiments, the media user can receive targeted advertisement through the cloud.

In some embodiments a consumer profile identity is determined in real time. A consumer profile identity can be determined by multiple interactions of the media user with a plurality of media. For example, a consumer accessing the interface of the method of the invention for the first time can have a profile identity determined in real time. A consumer previously known to the method of the invention can have a profile identity shaped over time.

The system of the invention allows for a range of different topics to be selected and searched. This versatility adds to the breath of categories from which a user can receive product information. For example: a) a consumer can select “fashion” and “beauty” as consumer markets of interest; b) a user can select “fashion”, “beauty” and “music”; c) a user can select “anime” and “music”, and in any scenario, a user receives a breath of different information on products associated with the consumer markets of choice.

A system of the invention can detect and monitor a consumer's use of one or any number of media devices. A media user can be engaged with one, two, three or any number of media devices simultaneously, sequentially, or intermittently, and the system of the invention can detect and monitor user engagement on all devices.

Accessing the system of the invention on the media by the media user alerts a computer system that the media user selected a selectable icon of choice, wherein each selectable icon is associated with one or several consumer markets associated with the entertainment experience. In some embodiments, the advertising targeting system further comprises a communication module, wherein the media device(s) are in communication with a common host via the communication module.

In some embodiments, the method of the invention is a computer program product comprising a computer readable medium having computer executable code adapted to be executed to implement a method for targeting advertising to a media user wherein the advertising targeting system comprises: a) a monitoring module, b) a first query module, c) a search module, and d) an advertising output module. For example, a system of the invention can identify a consumers interest in the fashion industry by monitoring a consumers' consumption of on demand fashion associated television shows. The system of the invention can launch a first query module in the form of selectable icons in the consumers' television set. The consumer can select one icon associated with the fashion industry. The consumer can select questions from a survey of the system of the invention to determine a submarket of choice within fashion. The consumer can select a fashion submarket of “shoes”. The user can further select submarkets of “shoes” such as “tap shoes” or “hunting shoes”. Product information is presented to the media user as one or a series of advertisement modules. In some embodiments the outputting by the advertising output module to the media user is an advertisement associated with the selectable icon that was selected.

### Advertising Output.

The method of the invention creates a targeted connection between a plurality of diverse parties using the advertisement output module in a media system as a point of interaction. Non-limiting examples of entities that can use the system of the invention to connect with targeted consumers include advertisers, merchants, publishers, religious organizations, recruiters, and non-profit organizations.

In some embodiments, the advertisement is presented to the media user as one or a series of selectable icons. The selectable icons can be, for example: a) displayed on any part of the media devices, including the center and edges; b) superimposed on the entertainment experience; c) photographs, images or drawings; d) sounds or music themes; and e) motion pictures. In some embodiments, the advertisement is presented to the media user within a search module. In some embodiments, consumer engagement is necessary for the launch of an advertisement output. In some embodiments consumer engagement is not necessary for the launch of an advertisement output.

In some embodiments the consumer can choose to review the content of the advertisement received and change their preferences by accessing the point of interaction created by the system of the invention. In some embodiments, different household members can share a plurality of media devices and use unique consumer identities to receive targeted advertisement. In some embodiments, a household can share a consumer identity profile.

Advertisers can choose to remain anonymous or not. For example, a marketing company can choose to showcase a specific product and keep their own identity anonymous. Recruiters can choose to showcase their association with a firm or company in an advertisement.

Advertisement content can contain, for example, product information, purchase information, sales information, virtual and in-store offers, virtual and in-store events, information on loyalty programs, educational information, religious information, travel information, and a plurality of niche advertisement specified by the consumer. For example, an advertising output module can guide a consumer to purchase an item. An advertising module can inform a consumer of an upcoming in-store sales event.

In some embodiments, selecting by the media user a selectable icon of the system of the invention launches a third party market channel, including third party websites. The consumer can receive targeted advertisement from the system of the invention while navigating a third party market channel. The consumer can effectuate purchases and subscriptions at a third party market channel. In some embodiments, the consumer can effectuate purchases and subscriptions using the interface of the method of the invention.

Advertising output can be tailored by the type of media used to access the method of the invention, for example, by viewership, demographics, behavioral variables, and psychographics. For example, a media user consuming media on a mobile device can receive a targeted advertisement as a window of selectable icons, wherein each selectable icon is associated with a consumer market associated with the entertainment experience. A media user consuming media on a television set or personal computer can receive a targeted advertisement as a motion picture with selectable icons, wherein each selectable icon is associated with a consumer market associated with the entertainment experience.

In some embodiments, a method of the invention displays a targeted advertisement into, for example: a) live or pre-recorded television shows; and b) live or pre-recorded webinars. The invention provides a method to target advertisement to the consumer demographic actively engaged with the media.

In some embodiments, a consumer can receive reminders of advertisements that were, for example, saved, viewed, and/or displayed by the methods of the invention.

### Virtual Advertisement Catalog.

Advertisers can access the point of interaction and populate a database with advertisements that they have created. Advertisers can access the point of interaction and populate a database with advertisements that others have created. Advertisers can provide qualitative and quantitative information on an advertisement. In some embodiments, the system of the invention functions as a database of advertisements. For example, advertisers can access the point of interaction of the method of the invention and answer a survey of selectable questions from their mobile devices, television sets, video game consoles, desktop and laptop computers. The survey can contain style choice questions that can be selected, and comment fields that can be populated with strategic marketing, creatives, or product choice words.

Advertisers can use the method of the invention as an exclusive method of advertisement, or in partnership with other methods of targeted advertisement. For example, a clothing store can use the method of the invention as their sole advertisement method, or a clothing store can use multi-pronged advertisement partnerships as a method of advertising. The method of the invention can monitor the advertising output received by a media user on a media device, wherein the advertising is sent by either the system of the invention or by a different party.

Consumers can access the point of interaction of the method of the invention and select selectable icons, wherein each selectable icon has an identity and is associated with one or more consumer markets. The method of the invention searches a database of advertisements, wherein the search is based on the identity of the consumer market icon that was selected. A virtual catalog of advertisement can be accessed when the consumer selects the icons presented to the media user on the media.

The user can access the point of interaction of the system of the invention on demand at any time from a plurality of media devices. A user can access a saved advertisement, request an additional advertisement, and effectuate transactions, such as purchases and subscriptions, on demand.

In one embodiment, monitoring the aggregated consumer use of different types of media by the method of the invention can be used to determine the most effective advertising vehicle. A merchant can estimate the economic value of a market by quantitating the consumption of advertisement in different types of media. For example, merchants can quantitate the number of video game consumers consuming video games and associated products on personal computers, video game consoles, and mobile devices. A merchant can, for example, determine the market price of products by quantitating consumer consumption.

### EXAMPLES

### Example 1

### Methods of Targeted Consumer Marketing

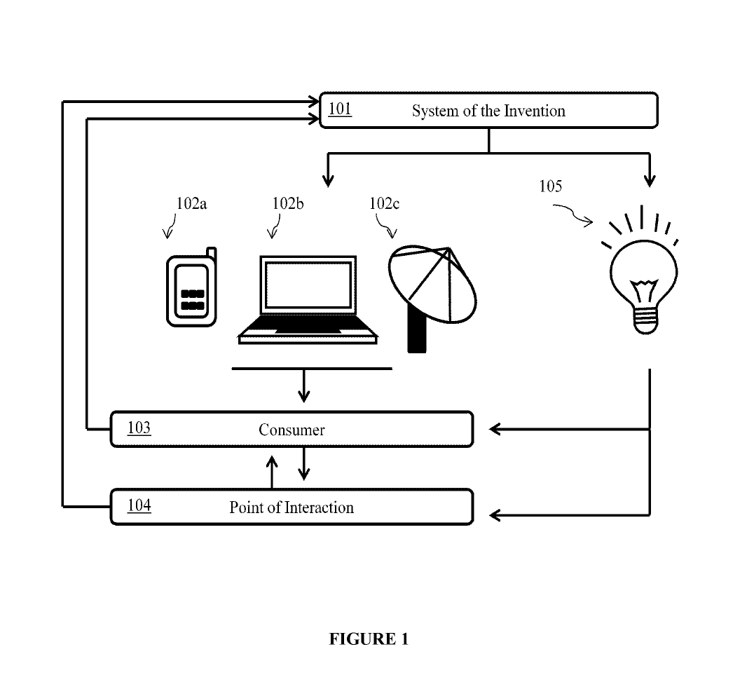

The system of the invention uses a range of sources to provide consumers with information on desired products. FIG. 1 illustrates a feedback-based advertising network that launches when software of the invention 101 communicates with a plurality of electronic devices 102. As depicted in FIG. 1, examples of media devices include personal computers 102b, mobile devices 102a, and satellite supported systems 102c, such as televisions. Consumer interaction with a plurality of media devices 102 triggers the first step in a feedback communication loop that culminates with the generation of targeted advertising. Consumer interaction with media, consumer online presence, and consumer input via the interface of the system of the invention 104 are used to generate a consumer profile identity. A consumer can select any number of selectable icons and a consumer can be asked to choose one or several consumer markets of choice using the technology of the system of the invention 104. In another scenario, a pixel sequencing module used by the system of invention 101 can detect the interest of the media user in any consumer market based on a pixel sequence of an image displayed on the media. Active and passive interaction with the selectable icons of the system of the invention, pixel sequencing of images displayed on media, internet browsing activities, internet search histories, and embedded software code are examples of sources of information used to create a consumer identity. The consumer identity guides the targeted selection of advertisement ideas 105 for a particular consumer 103. The consumer can, for example, actively choose to search a database of advertisement with a myriad of product ideas 105 by using the interface of the system 104 of the invention to select a plurality of icons associated with the interest. The network diagram highlights how consumer behavior determines the choices of advertisement.

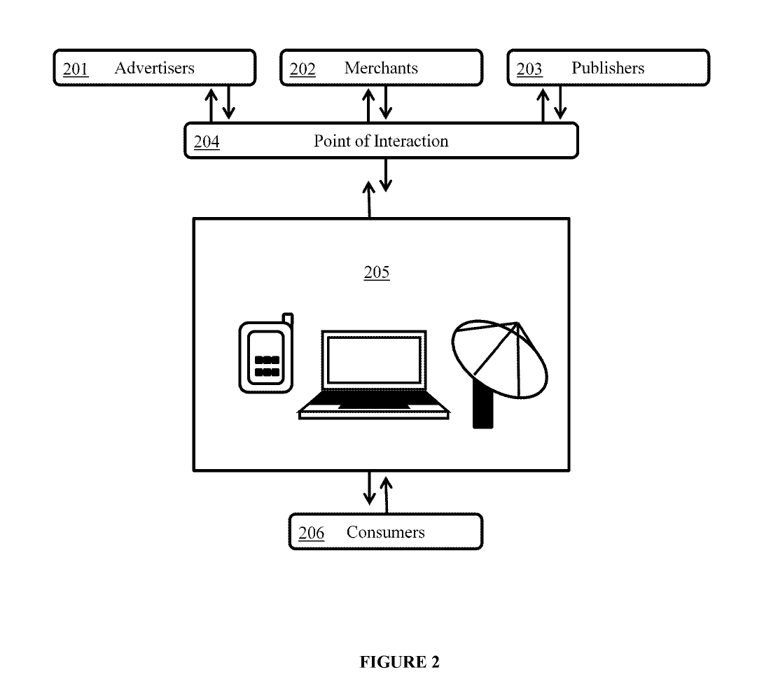

FIG. 2 is a non-limiting illustration of how different parties can interact with a system of the invention. A system of the invention effectively bridges the communication between consumers 206, advertisers 201, merchants 202 and publishers 203 by creating a method where advertisers 201, merchants 202 and publishers 203 can provide targeted advertisement to consumers 206 who have demonstrated an interested in specific consumer markets. The point of interaction 204 between consumers 206, advertisers 201, merchants 202 and publishers 203 is an advertising output module displayed on a plurality of media devices 205, wherein the advertisement is associated with a selectable icon. The advertisement output module displays advertisement reflecting the consumer preferences. Consumers can select a plurality of selectable icons and choose to: a) review the advertisement; b) purchase a product or service offered by the advertisement; c) ignore the advertisement; or d) save the advertisement for later review.

For example, the system of the invention can identify consumers who are using a range of media devices 205 to read comic books and to play video games with comic book themes. Publishers 203 can, for example, benefit from informing the consumer of the upcoming release of a new comic book series. In that scenario, the publisher 203 can interact with the system of the invention as a desired partner and complete a distinct set of survey questions to determine their fit into the consumer market structure established by the system of the invention 204. Consumers 206 can benefit from being informed of the release of the newest comic book series. The comic book consumer interaction with a plurality of media devices 205 can be detected by the system of the invention 204 wherein a module presents to the media user a plurality of selectable icons, wherein at least one selectable icon informs the consumer of the upcoming new comic book series release. Consumers 206 can select a plurality of selectable icons, wherein the selection alerts a computer system of the particular icons selected. Merchants 202 can, for example, perform a qualitative and quantitative analysis of the icons selected to survey the size of the comic book consumer market in a particular geographic area. Advertisers 201 can use the system of the invention 204 to interact with a plurality of media devices 105 and inform the consumer 206 of similar products available in the comic book, or in a related genre. The consumer receives the advertisement as an output from the media.

### Example 2

### Computer Architectures

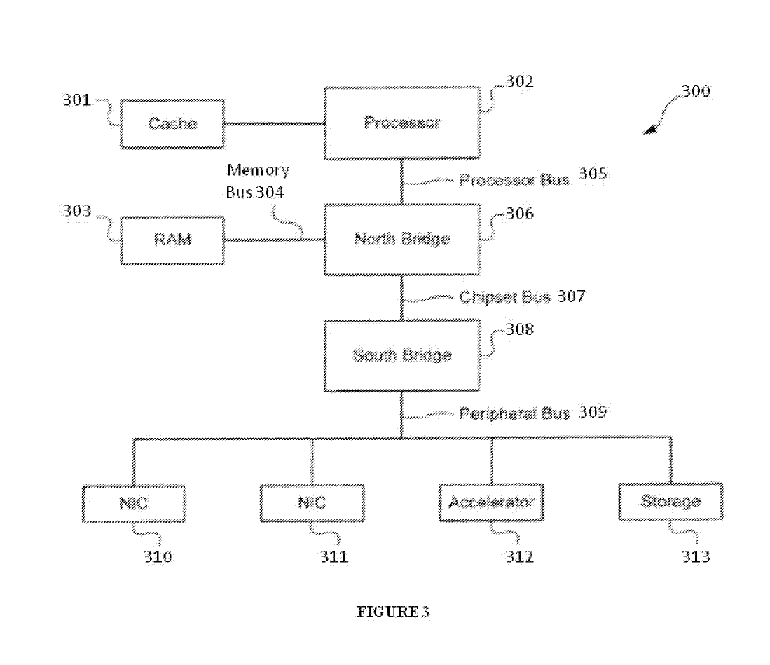

Various computer architectures are suitable for use with the invention. FIG. 3 is a block diagram illustrating a first example architecture of a computer system 300 that can be used in connection with example embodiments of the present invention. As depicted in FIG. 3, the example computer system can include a processor 302 for processing instructions. Non-limiting examples of processors include: Intel Core i7™ processor, Intel Core i5™ processor, Intel Core i3™ processor, Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can be used, whether in a single computer system, in a cluster, or distributed across systems over a network comprising a plurality of computers, cell phones, and/or personal data assistant devices.

### Data Acquisition, Processing and Storage.

As illustrated in FIG. 3, a high speed cache 301 can be connected to, or incorporated in, the processor 302 to provide a high speed memory for instructions or data that have been recently, or are frequently, used by processor 302. The processor 302 is connected to a north bridge 306 by a processor bus 305. The north bridge 306 is connected to random access memory (RAM) 303 by a memory bus 304 and manages access to the RAM 303 by the processor 302. The north bridge 306 is also connected to a south bridge 308 by a chipset bus 307. The south bridge 308 is, in turn, connected to a peripheral bus 309. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 309. In some architectures, the functionality of the north bridge can be incorporated into the processor instead of using a separate north bridge chip.

In some embodiments, system 300 can include an accelerator card 312 attached to the peripheral bus 309. The accelerator can include field programmable gate arrays (FPGAs) or other hardware for accelerating certain processing.

### Software Interface(s).

Software and data are stored in external storage 313 and can be loaded into RAM 303 and/or cache 301 for use by the processor. The system 300 includes an operating system for managing system resources; non-limiting examples of operating systems include: Linux, Windows™, MACOS™, BlackBerry OS™, iOS™, and other functionally-equivalent operating systems, as well as application software running on top of the operating system.

In this example, system 300 also includes network interface cards (NICs) 310 and 311 connected to the peripheral bus for providing network interfaces to external storage, such as Network Attached Storage (NAS) and other computer systems that can be used for distributed parallel processing.

### Computer Systems.

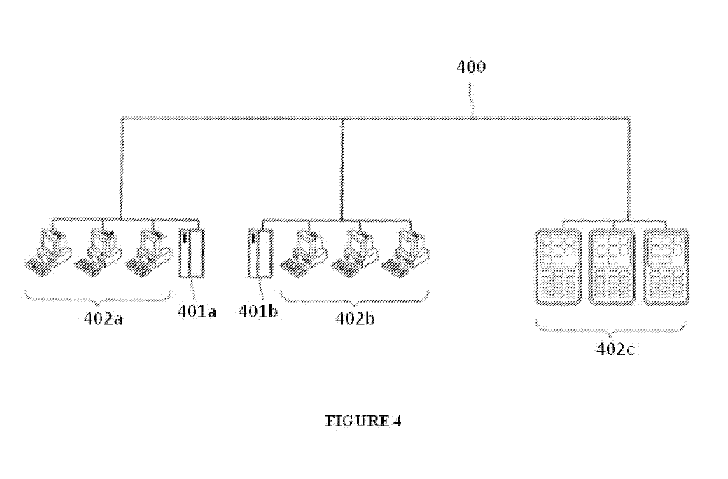

FIG. 4 is a diagram showing a network 400 with a plurality of computer systems 402a, and 402b, a plurality of cell phones and personal data assistants 402c, and Network Attached Storage (NAS) 401a, and 401b. In some embodiments, systems 402a, 402b, and 402c can manage data storage and optimize data access for data stored in Network Attached Storage (NAS) 401a and 402b. A mathematical model can be used for the data and be evaluated using distributed parallel processing across computer systems 402a, and 402b, and cell phone and personal data assistant systems 402c. Computer systems 402a, and 402b, and cell phone and personal data assistant systems 402c can also provide parallel processing for adaptive data restructuring of the data stored in Network Attached Storage (NAS) 401a and 401b. FIG. 4 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some embodiments, processors can maintain separate memory spaces and transmit data through network interfaces, back plane, or other connectors for parallel processing by other processors. In some embodiments, some or all of the processors can use a shared virtual address memory space.

### Virtual Systems.

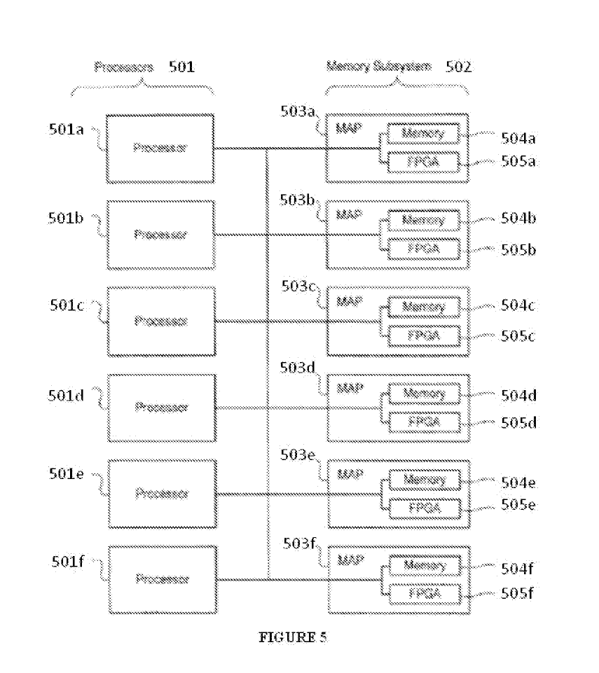

FIG. 5 is a block diagram of a multiprocessor computer system using a shared virtual address memory space. The system includes a plurality of processors 501a-f that can access a shared memory subsystem 502. The system incorporates a plurality of programmable hardware memory algorithm processors (MAPs) 503a-f in the memory subsystem 502. Each MAP 503a-f can comprise a memory 504a-f and one or more field programmable gate arrays (FPGAs) 505a-f. The MAP provides a configurable functional unit and particular algorithms or portions of algorithms can be provided to the FPGAs 505a-f for processing in close coordination with a respective processor. In this example, each MAP is globally accessible by all of the processors for these purposes. In one configuration, each MAP can use Direct Memory Access (DMA) to access an associated memory 504a-f, allowing it to execute tasks independently of, and asynchronously from, the respective microprocessor 501a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. Any variety of data storage media can be used in connection with example embodiments, including random access memory, hard drives, flash memory, tape drives, disk arrays, Network Attached Storage (NAS) and other local or distributed data storage devices and systems.

In example embodiments, the computer system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 5, system on chips (SOCs), application specific integrated circuits (ASICs), or other processing and logic elements. For example, the Set Processor and Optimizer can be implemented with hardware acceleration through the use of a hardware accelerator card, such as accelerator card 312 illustrated in FIG. 3.

### EMBODIMENTS

### Embodiment 1

In some embodiments, the invention provides a method of advertising to a media user, the method comprising: a) monitoring the media user's media entertainment to detect an interest of the media user in a consumer market based on an interaction of the media user with the media, wherein the monitoring and the detecting are performed by a computer system; b) launching by the computer system a module within the media; c) presenting to the media user via the module a first plurality of selectable icons based on the media user's interest, wherein each selectable icon is associated with the consumer market; d) detecting by the computer system that one of the selectable icons has been selected, wherein the selectable icon that has been selected has an identity; e) searching by the computer system a database of advertisements, wherein the search is based on the identity of the selectable icon that has been selected, to identify an advertisement associated with the consumer market, wherein the computer system comprises a processor, and the search is performed by the processor; and f) presenting to the media user via the media the advertisement associated with the consumer market.

### Embodiment 2

The method of embodiment 1, wherein upon detecting that one of the selectable icons has been selected, presenting to the media user via the media a second plurality of selectable icons, wherein each selectable icon of the second plurality is independently associated with a submarket within the consumer market, wherein the searching is further based on the submarket upon detecting by the computer system that one of the selectable icons of the second plurality has been selected.

### Embodiment 3

The method of any one of embodiments 1 and 2, wherein the interest of the media user is detected based on a pixel sequence of an image displayed on the media.

### Embodiment 4

The method of any one of embodiments 1-3, wherein the computer system monitors the media user's media entertainment on at least two of: a personal computer, a television, a telephone, and a video game console.

### Embodiment 5

The method of any one of embodiments 1-3, wherein the computer system monitors the media user's media entertainment on all of: a personal computer, a television, a telephone, and a video game console.

### Embodiment 6

A method of accessing advertising on media by a media user, the method comprising: a) accessing on the media by the media user a module associated with a media entertainment experience, wherein the module presents to the media user a plurality of selectable icons, wherein each selectable icon is associated with a consumer market associated with the entertainment experience; b) selecting by the media user one of the selectable icons, thereby selecting the consumer market associated with the selectable icon that was selected, wherein the selection alerts a computer system that the media user selected the selectable icon that was selected, whereupon the computer system searches a database for an advertisement associated with the consumer market associated with the selectable icon that was selected and presents the advertisement to the media user, wherein the search is performed by a processor; and c) receiving the advertisement by the media user via the media.

### Embodiment 7

The method of embodiment 6, wherein the media user encounters the module by engaging in the media entertainment experience, wherein the computer system detects that the media user is engaged in the media entertainment experience.

### Embodiment 8

The method of embodiment 7, wherein the computer system detects that the media user is engaged in the media entertainment experience based on a pixel sequence of an image displayed on the media.

### Embodiment 9

The method of any one of embodiments 6-8, wherein the computer system monitors at least two of the media user's: personal computer, television, telephone, and video game console.

### Embodiment 10

The method of any one of embodiments 6-8, wherein the computer system monitors all of the media user's: personal computer, television, telephone, and video game console.

### Embodiment 11

A computer program product comprising a computer-readable medium having computer-executable code encoded therein, the computer-executable code adapted to be executed to implement a method for targeting advertising to a media user, the method comprising: a) providing an advertising targeting system, wherein the advertising targeting system comprises: i) a monitoring module; ii) a first query module; iii) a search module; and iv) an advertising output module; b) monitoring the media user's media access via the monitoring module to detect an interest of the media user in a consumer market; c) querying the media user with a first query by the first query module, based on the interest, wherein the first query presents to the media user a first plurality of selectable icons associated with the interest; d) detecting by the first query module that one of the selectable icons has been selected, wherein the selectable icon that has been selected has an identity; e) searching by the search module a database of advertisements based on the identity of the selectable icon that has been selected, wherein the search identifies an advertisement associated with the selectable icon that was selected; and f) outputting by the advertising output module to the media user over the media the advertisement associated with the selectable icon that was selected.

### Embodiment 12

The computer program product of embodiment 11, wherein the advertising targeting system further comprises a second query module, wherein the second query module queries the media user with a second query, wherein the second query is based on the selectable link that was selected in response to the first query, wherein the second query presents to the media user a second plurality of selectable icons, each independently associated with a submarket within the consumer market, wherein the second query module detects that one of the selectable icons associated with a submarket has been selected, and wherein the searching is further based on the submarket.

### Embodiment 13

The computer program product of any one of embodiments 11 and 12, wherein the advertising targeting system further comprises a pixel sequencing module, wherein the pixel sequencing module detects the interest of the media user in the consumer market based on a pixel sequence of an image displayed on the media.

### Embodiment 14

The computer program product of any one of embodiments 11-13, wherein: the advertising targeting system further comprises a communication module; and the computer program product is installed on at least two media devices, wherein the media devices are: a personal computer, a television, a telephone, and a video game console, wherein the media devices on which the computer program product is installed are in communication with a common host via the communication module.

### Embodiment 15

The computer program product of any one of embodiments 11-13, wherein: the advertising targeting system further comprises a communication module; and the computer program product is installed on all of: a personal computer, a television, a telephone, and a video game console, wherein all of the personal computer, the television, the telephone, and the video game console are in communication with a common host via the communication module.

What is claimed is:

1. A method of advertising to a media user, the method comprising:
a) monitoring the media user's media entertainment to detect an interest of the media user in a consumer market based on an interaction of the media user with the media, wherein the monitoring and the detecting are performed by a computer system;
b) launching by the computer system a module within the media;
c) presenting to the media user via the module a first plurality of selectable icons based on the media user's interest, wherein each selectable icon is associated with the consumer market;
d) detecting by the computer system that one of the selectable icons has been selected, wherein the selectable icon that has been selected has an identity;
e) searching by the computer system a database of advertisements, wherein the search is based on the identity of the selectable icon that has been selected, to identify an advertisement associated with the consumer market, wherein the computer system comprises a processor, and the search is performed by the processor; and
f) presenting to the media user via the media the advertisement associated with the consumer market.

2. The method of claim 1, wherein upon detecting that one of the selectable icons has been selected, presenting to the media user via the media a second plurality of selectable icons, wherein each selectable icon of the second plurality is independently associated with a submarket within the consumer market, wherein the searching is further based on the submarket upon detecting by the computer system that one of the selectable icons of the second plurality has been selected.

3. The method of claim 1, wherein the interest of the media user is detected based on a pixel sequence of an image displayed on the media.

4. The method of claim 1, wherein the computer system monitors the media user's media entertainment on at least two of: a personal computer, a television, a telephone, and a video game console.

5. The method of claim 1, wherein the computer system monitors the media user's media entertainment on all of: a personal computer, a television, a telephone, and a video game console.

6. A method of accessing advertising on media by a media user, the method comprising:
a) accessing on the media by the media user a module associated with a media entertainment experience, wherein the module presents to the media user a plurality of selectable icons, wherein each selectable icon is associated with a consumer market associated with the entertainment experience;
b) selecting by the media user one of the selectable icons, thereby selecting the consumer market associated with the selectable icon that was selected, wherein the selection alerts a computer system that the media user selected the selectable icon that was selected, whereupon the computer system searches a database for an advertisement associated with the consumer market associated with the selectable icon that was selected and presents the advertisement to the media user, wherein the search is performed by a processor; and
c) receiving the advertisement by the media user via the media.

7. The method of claim 6, wherein the media user encounters the module by engaging in the media entertainment experience, wherein the computer system detects that the media user is engaged in the media entertainment experience.

8. The method of claim 7, wherein the computer system detects that the media user is engaged in the media entertainment experience based on a pixel sequence of an image displayed on the media.

9. The method of claim 6, wherein the computer system monitors at least two of the media user's: personal computer, television, telephone, and video game console.

10. The method of claim 6, wherein the computer system monitors all of the media user's:
personal computer, television, telephone, and video game console.

11. A computer program product comprising a computer-readable medium having computer-executable code encoded therein, the computer-executable code adapted to be executed to implement a method for targeting advertising to a media user, the method comprising:
a) providing an advertising targeting system, wherein the advertising targeting system comprises:
i) a monitoring module;
ii) a first query module;
iii) a search module; and
iv) an advertising output module;
b) monitoring the media user's media access via the monitoring module to detect an interest of the media user in a consumer market;
c) querying the media user with a first query by the first query module, based on the interest, wherein the first query presents to the media user a first plurality of selectable icons associated with the interest;
d) detecting by the first query module that one of the selectable icons has been selected, wherein the selectable icon that has been selected has an identity;
e) searching by the search module a database of advertisements based on the identity of the selectable icon that has been selected, wherein the search identifies an advertisement associated with the selectable icon that was selected; and
f) outputting by the advertising output module to the media user over the media the advertisement associated with the selectable icon that was selected.

12. The computer program product of claim 11, wherein the advertising targeting system further comprises a second query module, wherein the second query module queries the media user with a second query, wherein the second query is based on the selectable link that was selected in response to the first query, wherein the second query presents to the media user a second plurality of selectable icons, each independently associated with a submarket within the consumer market, wherein the second query module detects that one of the selectable icons associated with a submarket has been selected, and wherein the searching is further based on the submarket.

13. The computer program product of claim 11, wherein the advertising targeting system further comprises a pixel sequencing module, wherein the pixel sequencing module detects the interest of the media user in the consumer market based on a pixel sequence of an image displayed on the media.

14. The computer program product of claim 11, wherein:
the advertising targeting system further comprises a communication module; and
the computer program product is installed on at least two media devices, wherein the media devices are: a personal computer, a television, a telephone, and a video game console,
wherein the media devices on which the computer program product is installed are in communication with a common host via the communication module.

15. The computer program product of claim 11, wherein:
the advertising targeting system further comprises a communication module; and
the computer program product is installed on all of: a personal computer, a television, a telephone, and a video game console,
wherein all of the personal computer, the television, the telephone, and the video game console are in communication with a common host via the communication module.
